(19) United States
(12) Patent Application Publication
(10) Pub. No.: US 2009/0200302 A1
(43) Pub. Date: Aug. 13, 2009

(54) SEALING MACHINE

(75) Inventors: Peter Gysi, Bellikon (CH); Marcel Oberholzer, Kindhausen (CH)

Correspondence Address: MCCORMICK, PAULDING & HUBER LLP, CITY PLACE II, 185 ASYLUM STREET, HARTFORD, CT, 06103, US

(73) Assignee: Soudronic AG, Bergdietikon (CH)

(21) Appl. No.: 11/719,416

(22) PCT Filed: Nov. 15, 2005
(86) PCT No.: PCT/CH05/00675

§ 371 Date: May 16, 2007

(30) Foreign Application Priority Data
Nov. 19, 2004 (CH) 1920/04
Feb. 15, 2005 (CH) 275/05

(51) Int. Cl. B29C 65/02; B29C 65/48; B65B 7/28; B29C 65/00

(52) U.S. Cl. 220/254.1; 220/265; 156/60; 156/556; 156/510; 156/499

(57) ABSTRACT

Foil blanks are used in the packaging industry in the form of covering for metal lid rings. The invention relates to a method and processing machine for adhering a foil blank onto a lid ring comprising a first partial adhering step and a second completing adhering step, and the lid rings so formed.

### NOTICE OF RELATED APPLICATIONS

This application claims the priority of Swiss Patent Application Nos. 01920/04 and 275/05, which were filed respectively on 19 Nov. 2004 and on 15 Feb. 2005 and the entire disclosures of which are herewith incorporated by reference.

### BACKGROUND

The present invention concerns a method according to claim 1, a processing machine according to claim 9 and a cover ring according to claims 23 and 24.

### STATE OF THE ART

Packages made of different materials, especially packages made of sheet material, or packages made of hybrid materials, are known and are used in many ways. A mass market exists for many packages, for example, for foods or in the field of colors and oils; however special packages are also requested.

Plastic packages and plastic package parts such as covers, closable spouts, tear-off outlets, threaded closures etc. can be made cheaply by injection molding methods and are suited for the packaging of easily spoiled food materials. Such packages are mechanically rather simple; but nevertheless have complexly shaped parts, often movable parts, which must be made with high precision.

Sheet metal packages have high mechanical stability and serve for the long time storage of different contents such as food materials, colors and paints up to munitions or further for the short or long time protection of their contents. According to the nature of things reclosable sheet metal packages are difficult to make and are rare, especially when the contents after the reclosure are to be reliably isolated and sealed against environmental influences.

Hybrid packages can combine various advantages: a tear off foil associated with the cover can then be first removed when the contents after an eventual long storage period are to be consumed. Above all plastic covers are suited for providing a renewed closure since their comparatively pliant outer surface lies in the way of a sealing element at the edge of the opening of the package if the edge through use or during storage is not very much deformed. Above all in the case of large packages it is accordingly necessary that the package body be rigidly made which, can be achieved if necessary through the use of expensive composite material.

For some applications packaging elements have become known which include a spanning cover carrier, for example, a cover ring made of sheet metal such as tin plate or aluminum, which is covered by a foil. The foil spans over and closes the removal opening of the package. After removal of the foil, a reusable cover can be used as a temporary closure for the removal opening, with the stability of the cover ring influencing the closure effect. Independently of the question of reclosability such cover rings can be formed from sheet metal, for example, by beading onto a package body, with the advantage, that then the need is removed for providing a cover of sheet metal which must either be opened by a can opener or must be made expensively as a scored tear-off cover.

Cover rings of the mentioned kind are preferably made on a linear machine (or also on expensively constructed carrousel machines). Involved in the case of linear machines is an arrangement of processing stations disposed behind one another, which processing stations are connected with one another by a step controlled transport for the parts to be processed and which processing stations are likewise controlled in stepwise manner so that during each step each processing station carries out its working procedure on the then involved work piece.

A known machine of the mentioned kind is shown in FIG. 1. Schematically illustrated are processing machines forming a linear machine 1 having a conveyor, formed for example as a chain transport 2, running through it for the parts to be processed and which serves the various processing stations.

A magazine 3 is provided for the lid rings 20 (FIG. 2), in which magazine the rings 20 are individualized and step-wise transferred to the conveyor 2 so that in keeping with the processing stepping rate they are taken to the various further processing stations and eventually are discharged from the machine by way of a discharge station 6, with the lid ring having been covered with a foil blank.

A positioning station 4 is formed as a combination station for several working steps and is illustrated in more detail in FIG. 3. Delivered to the station 4 is a nonillustrated foil web from which a foil blank is first stamped and which foil blank is secondly positioned on the lid ring 20. Directly upon this positioning there takes place, as a third step the connection of the foil blank and the lid ring 22 one another (preferably the foil web, and thereby also the stamped out foil blank, is coated with an adhesive activateable by heat, which permits the adhesion of the lid ring 20 and the foil blank to one another under the effect of heating). The lid ring 20 covered with the foil blank then moves subsequently by way of the chain conveyor 2 into a folding and embossing station 5.

In this station 5 an eventual tongue is provided on the foil blank by folding, so that it lies on the foil blank, and as the case may be an embossing is applied to the foil blank. The station 6, as explained, is the discharge station for the lid rings 20 which each have been covered by a foil.

Instead of the terms “adhering or to adhere” in the state of the art for the present connecting techniques the terms “sealing or to seal” are also used.

FIG. 2 shows a cross section taken through a cover carrier formed as a lid ring 20 made of sheet material, for example tin plate, and covered by a foil. It can have an outer diameter of 56 millimeters or less, but can also have an outer diameter of up to 153 millimeters or more. Its outer edge 21 serves for the later connection with the body of a package, which may likewise be made of tin plate or from some other metallic or non-metallic material. The interior of the ring consists of a wall section 22 which advances into a shoulder 23 which likewise is bordered by a folded down inner edge 24. By way of the wall section 22, the rather sensitive location of the connection between the lid ring 20 and the foil blank 30 is displaced into the protected interior of the lid ring 20 on one hand, and on the other hand the wall section 22 provides an engagement surface for a further reusable lid, which to simplify the figure is not illustrated. The inner edge 24 is folded down so that in regard to the removable foil section 30 no danger of injury from sharp sheet metal edges exists. Moreover, this simple folded structure of the lid ring 20 provides a high mechanical stability.

The foil blank 30 can consist of a composite foil with different layers; it has in any case, as mentioned above, as one of its outer sides a layer of adhesive, such as polyethylene or polypropylene, etc., which is preferably activateable by heat. It is, however, completely within the bounds of the invention that the adhesive is not applied fixedly to the foil and that it can, for example, be separately delivered. The other layers can be of metallic or non-metallic nature, in keeping with the desired properties of the foil in respect to mechanical rigidity, corrosion resistance or conservation capabilities, etc.

As shown in the figure, the foil blank 30 and the shoulder 23 overlap one another in an overlapping zone indicated by the arrow 31. The adhesive connection 32 is indeed not formed in the entirety of the overlapping zone 31, but only in a connecting zone 33. An outermost edge section 34 of the foil blank 30 remains unsecured by adhesive. The zone 33 and the section 34 are likewise shown by arrows in the figure.

The foil blank 30 covers the opening 25 of the lid ring 20. Although in the figure a rotationally symmetric cover carrier is shown, non-circular, that is oval, rectangular and other shapes, can be covered by a foil blank and used for the mentioned purpose; the teaching according to the invention can be used in unlimited manner on all configurations of covered carriers and is not limited to the round lid ring 20 illustration the figure. The term “lid ring” is to be understood in this wider sense. The overlapping zone 31 has a width of 3 mm and the connecting zone 31 a width of 2 mm, which in the case of a frequent outer diameter of the lid ring 20 of for example 76 mm or even more, permits a bursting pressure (that means a pressure at which the adhesively secured foil blank breaks from the lid ring) of 2 bar or higher.

FIG. 3 shows in cross section the positioning station 4 of FIG. 1 as known in the state of the art. Movable parts have the direction of their back and forth movements indicated by double arrows; unmovable parts which are rigidly fixed to the station 3 have their immobility indicated by grounding symbols. For simplification of the figure omitted from it are the drives for the movable parts as well as other organs of the station 4 which are not necessary for its function; a specialist in the art can supply the omitted parts and organs of this conventional processing station at any time from his own knowledge.

The figure shows a conveyor dog 17 of the conveyor 2 which support the lid ring 20 for processing. Under the lid ring 20 is a support 40 with a supporting surface 41 for the shoulder 23 of the lid ring 20. When the support 40 moves upwardly it engages the shoulder 23 with the support surface of 41 and lifts the lid ring 20 likewise upwardly.

A foil web 43 is indicated by the broken line and runs transversely through the positioning station 4.

A foil cutting work tool 45 with a knife 46 and a gripper 47 having gripping tongs is so arranged that the foil web 43 runs through the gripping tongs and by a closing movement of these is clamped fast and lifted.

Above the gripping tongs 47 is the knife 46 which has a downwardly facing cutting edge 48. The cutting edge 48 has the shape of the foil blank 30 to be stamped out.

By the gripping of the gripping tongs 47 the foil web 48 is fixed in its position. When the gripping tongs 47 subsequently move upwardly, the foil web 43 comes into contact with the cutting edge 48; when the gripping tongs 48 moves still further upwardly, the knife 46 stamps the foil blank 30 from the foil web 43. The circumference of the foil blank 30 corresponds to the outer contour of the cutting edge 48.

Further illustrated in the figure is a positioning means formed as a stamp 50 for the foil blank 30 with an effective outer surface region 51, and a low pressure section 42 surrounded by the region 51, in which low pressure section 52 a low pressure is created by the sucking away of air through a conductor not illustrated in the figure.

During the stamping procedure the stamp 50 is arranged at an upper end position so that with respect to the gripping tongs and the knife 46 its effective surface region 51 lies in the plane defined by the cutting edge 48 of the knife 46. The foil web 43 during the stamping procedure lies next to the outer surface area 51. The simultaneous activation of a low pressure in the low pressure section 52 has the result that the stamped out foil blank 30 remains held to the outer surface area 51. The stamp 50 now moves with the held foil blank 30 downwardly into its lower end position and positions the foil blank 30 in the adhering position onto the shoulder 23 of the lid ring 20 resting on the support 40. The stamp 50 and the support 40 are at this time in their adhering positions and clamped between themselves, by way of their outer surface area which directly face one another, namely the outer surface region 51 and the support surface 41, are the foil blank 30 and the lid ring 20 which are now in contact with one another for an adhesion joining. Heating elements not illustrated in the drawing, which preferably are arranged in the support 40 and in the stamp 50 create the needed heat so that in this adhesion position of the foil blank 30 and the seal ring 20 the adhesive layer of the foil is fluidized and enables the adhesion of the foil blank to the lid ring. In this procedure the stamp 50 and the support 40 work as means for the adhesion or gluing of the foil blank 30 and the lid ring 22 one another.

According to the kind of foil used and the amount of adhesive used for the adhering step additional pressure may be applied to the connecting zone 33. By a corresponding drive the stamp 30 is pressed with the needed force against the blank 30 between the outer surface areas 41 and 51.

Together the support 40 an the stamp 50 move away from one another so that the conveyor 2 can bring a new lid ring 20 into the working position and so that at the same time the lid ring 20 now covered by the foil blank 30 can be taken from the station 4, so that then again the support 40 and stamp 50 can be moved to stamp out a foil blank 30, to position it on the lid ring 20 and to subsequently adhere the blank and ring to one another.

It is especially advantageous in the configuration illustrated in FIG. 3 that the different functions are combined in a single processing station, so that upon the stamping out of a foil blank 30, except for its spacing, its position with respect to the shoulder 23 of the lid ring 20 is already defined. This eliminates the expense for a separate station (as is likewise known in the state of the art) for the stamping out of the foil blanks 30, and likewise this eliminates a necessary additional conveying and positioning mechanism. The illustrated configuration therefore permits an essentially increased stepping rate up to the region of 80 to 100 steps per minute, because the previously necessary positioning considerably robbing of time, is eliminated.

A disadvantage of the configuration shown in FIG. 3 exists in that the movement procedures (stamping out of the foil blank 30 and the lowering of the stamp 50 into the adhering position) still require a considerable portion of the step time, so that for the adhering process itself there remains only a limited amount of remaining available time, with the consequence, that the stepping rate cannot be further increased.

### DESCRIPTION OF THE INVENTION

Accordingly it is the object of the present invention to provide a processing machine allowing a stepping rate of more than 100 steps per minute.

This object is solved by a method according to claim 1 and by a processing machine according to claim 9.

Therefore in that the adhering procedure is broken up into several partial steps, more time is made available for the adhesion itself since it corresponds to one individual timewise step of the processing machine. Therefore, the stepping time can be shortened and the stepping rate increased. Also, since for the positioning of the foil blank 30 onto the lid ring 20 the above described conventional positioning station can be used again, the positioning of the foil blank 30 on the lid ring 20 can be accomplished in a simple way without additional positioning means.

In a preferred embodiment of the method of the invention according to claim 3, in regard to the stated object, an improved lid ring 20 according to claim 23 and an improved foil covered lid ring 20 according to claim 24 can be made. Since the first adhesion step in the positioning station 4 takes place on a predetermined partial area 56 (see FIG. 6a) of the connecting zone 33 between the foil blank 30 and the lid ring 20, the additional adhesion step in the further processing station at the previously non-adhered, outermost edge section 34 of the foil blank 30 takes place with the consequence that the necessary width of the shoulder 23 can be reduced from 3 mm to 2 mm (as explained in connection with FIG. 6a and FIG. 6b).

The reduced width of the shoulder effects on one hand a considerable saving of material expense, since in the mass production of packages, the material consumption forms the highest part of the involved costs; and on the other hand, an improved functionality is achieved since the package in use when tipped over can now be better or almost entirely emptied.

As previously stated, the advantages of the invention come into play especially in the case of a processing machine formed as linear machine, since the stepping time is reduced and accordingly the stepping rate can be increased. In the case of a carrousel machine the problem is not so much the stepping time, since the diameter of the carrousel has to be suited to the needed processing time. Where for example on grounds of space the diameter of carrousel is limited, the advantages of the invention also apply analogously to a carrousel machine.

Independently of the processing time and the geometric layout it is evident that as above described by the method according to claim 3 improved lid rings according to claim 23 or claim 24 can also be used newly in a carrousel machine or made in a carrousel machine.

### BRIEF DESCRIPTION OF THE DRAWINGS

Further implementations, advantages and uses of the invention will be apparent from the dependent claims and from the following description based on the accompanying figures. The figures are:

FIGS. 1-3 views for explaining the state of the art;

FIG. 4 a schematic illustration of a processing machine according to the invention and formed as a linear machine,

FIG. 5 a schematic partial view of a further processing station 7 of the machine of FIG. 4 for carrying out the further adhesion steps,

FIG. 6a a cross section through a lid ring 20 which in the positioning station 4 is adhesively bonded with the foil blank 30 in a predetermined partial region 56 of the connecting zone 33,

FIG. 6b a cross section through the lid ring of FIG. 6a which in the further processing station 7 is subjected to an additional adhering step and;

FIG. 7 several examples for the formation of the first, predetermined partial adhesion step and for the implementation of the further adhesion step.

### WAYS FOR CARRYING OUT THE INVENTION

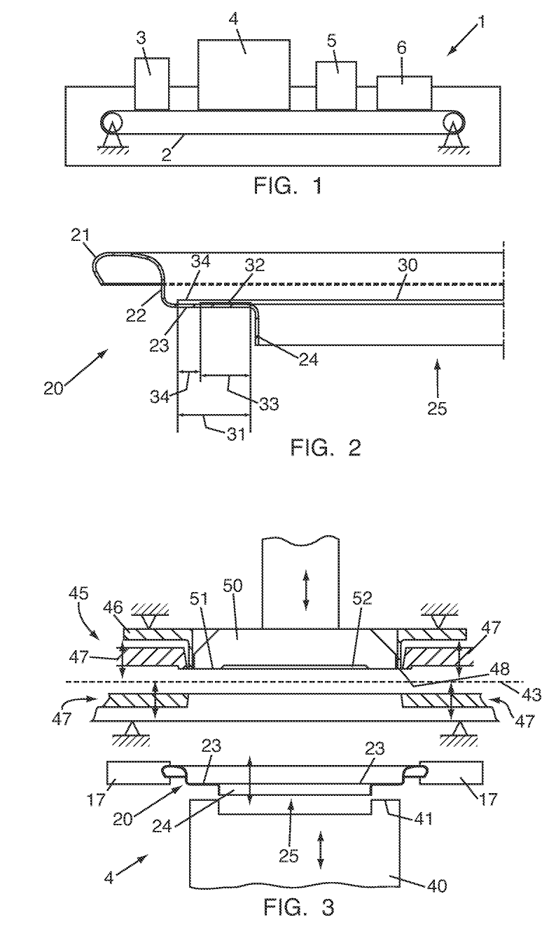

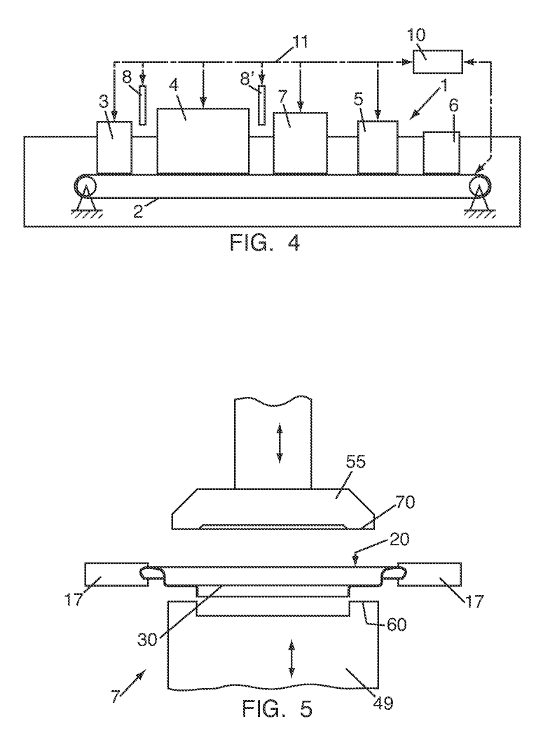

In FIG. 4 the processing machine of FIG. 1 is illustrated as supplemented in accordance with the invention by a further processing station 7 as well as by preheating stations 8 and 8′. A control 10 is operably connected with the stations 3 to 8′ as well as with the conveyor 2 by means of data conductors 11.

Heating means are provided in the pre-warming station 8 which, for example, by induction, preheat the lid rings 20 supplied to the positioning station 4 by the conveyor 2. Likewise the pre-warming station 8′ includes such heating means for the purpose of maintaining heat in the lid rings 20 discharged from the positioning station 4 (which lid rings have already for example have a foil blank 30 adhered to a predetermined partial region of the connecting zone 33), for example to hinder a cooling of the lid rings or to bring them to a desired temperature before they are taken into the further processing station 7 for the supplemental adhesion step.

FIG. 5 shows a portion of the further processing station 7 in which the supplemental adhesion step takes place, and which in its construction basically corresponds to the positioning station 4. Above all a foil cutting tool 45 is not provided. Illustrated are the means for the advanced adhesion of the lid ring 20 and the foil blank 30 to one another, namely a support 49 and a stamp 55 with the associated directly facing outer surface areas 60 and 70. The lid ring 20 with a foil blank 30 partially adhered to it is held by the conveyor dogs 17.

As in the positioning station 4 in the processing station 7, when the support 49 and the stamp 55 have been moved away from one another, the lid ring 20 can be moved into and between these parts or can be moved out of these parts; likewise the support 49 and the stamp 52 are movable toward one another into the adhering position for the advancement of the adhesion and sealing of the lid ring 20 to and by its foil blank 30 in the adhering position and in contact between the support 49 and stamp 55.

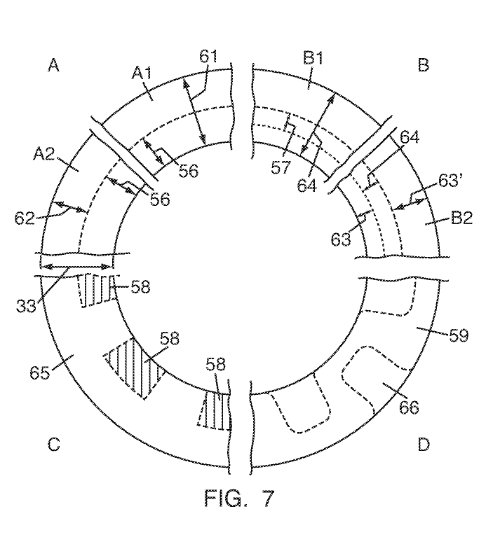

The effective outer surface areas 60, 70 preferably have another shape and geometry as compared to that of the effective outer surface areas 41, 51, and work correspondingly preferably on dissimilar regions of the connecting zone 33 of the lid ring 20 and foil blank 30, as is for example shown in FIG. 7.

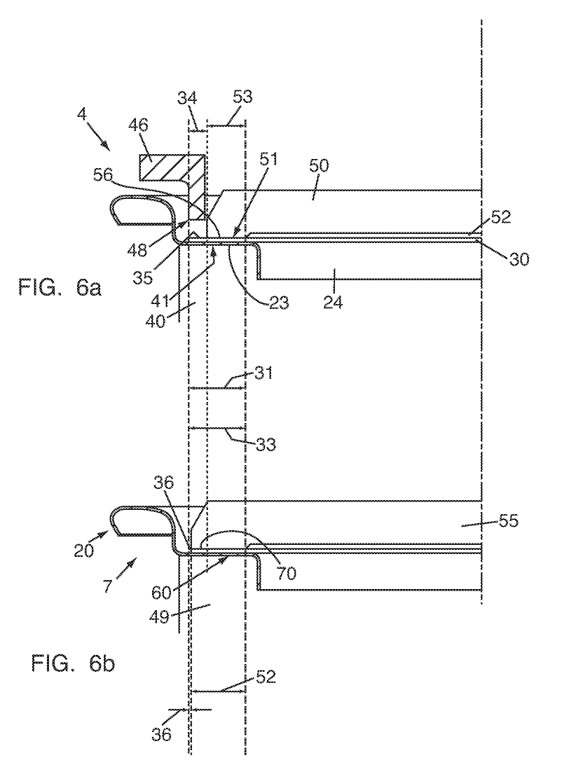

To clarify the sequentially occurring adhering steps, FIGS. 6a and 6b show the same lid ring 20 which (first) according to FIG. 6a is located in the positioning station 4 and then (in the next step of the machine) is located in the further processing station 7 as shown in FIG. 6b. The figures are so arranged above one another that with the help of the broken, pointed and crossed lines the advancement of the adhesion can be recognized.

Between the broken and the crossed lines the overlapping zone 31 of the shoulder 23 and foil blank 30 is noted. In the illustrated case, and preferably, the overlapping zone 31 corresponds exactly to the connecting zone 33 between the lid ring 20 and foil blank 30. This is different from the conventional lid ring 20 according to FIG. 1, where the connecting zone 33 is a little less wider than the overlapping zone 31, and where accordingly an outermost edge section 34 remains un-adhered, which is disadvantageous.

As mentioned, FIG. 6a shows the lid ring 20 in the positioning station 4, with the already positioned foil blank 30, at the moment of the adhering. The lid ring 20 rests with its shoulder 23 on the support surface 41 of the support 40. The stamp 50 is by way of its effective outer surface 51 in contact with the foil blank 30 whereby the effective outer surface 51 and the support surface 41 cover a covered zone 53 lying between the pointed and the crossed lines.

Heating means (which for simplification of the figure have been omitted) are located in the support 40 and/or in the stamp 50 and heat the outer surfaces 41, 51 facing one another, so that in the covered zone 53, an adhesion is created. Since this covered zone is of less width then the connecting zone 33 there results for the time being an adhesion only in the corresponding predetermined partial region 56 of the connecting zone 33.

Since the sleeve-like shaped knife 46 located inside of the stamp 50 for the stamping out of the foil blank 30 has to be withdrawn, its outer diameter can not be larger than the internal diameter of the knife edge 48 carrying portion of the knife 46, with the result, that the still un-adhered edge section 34 can not be avoided.

FIG. 6b shows the lid ring 20 in the further processing station 7, where the additional adhesion step is carried out. The lid ring 20 in the region of the covered zone 52 is clamped between the support surface 60 of the support 49 and the effective outer surface 70 of the stamp 55. For simplifying the figure the heating means in the support 45 and/or in the stamp 55 for heating the outer surface 60, 70 have been omitted, insofar as such heating is needed for the adhesion. Since the overlapping zone 52 corresponds to the connecting zone 33 (and therefore is wider than the overlapping zone 53), the connecting zone 43 is now entirely adhered and the predetermined partial region 56 (FIG. 6a) is at the same time re-adhered by the renewed heating.

Preferably, but nor compellingly, the overlapping zone 52 can be of such measurement that a comparatively very small edge region 36 still remains un-adhered, so that during the adhering process at the edge of the connecting zone 33, no flowing mass of adhesive eventually escapes outwardly and dirties the lid ring.

Preferably the connecting zone 33 has a width of 2 mm, which in the case of known foils (for example ALUFIX from Alcan) for stamped foil blanks 30 having a diameter up to 96 mm makes possible a bursting pressure of more than 2 bar. A higher burst pressure is for example necessary, if the packaging contents are to be sterilized.

The thickness of the cutting edge 48 carrying portion of the knife 46 as is to be found in the state of the art and as is illustrated in FIGS. 3 and 6a, is about 1 mm, with the result, that the covered zone 53 likewise has a width of 1 mm, which then also applies for the as yet un-adhered edge section 34.

In the additional adhesion step the predetermined partial region 56, as already indicated, can without further ado be once again re-adhered (that is, by the heating effect be once again subjected to the adhering process). Alternatively, according to the foil and the used adhesive material the position of the overlapping zone 52 can also be exclusively (or partially) complementary to the predetermined partial region 56, so that the overlapping zone 52 and the predetermined partial region 56 complete the connecting zone 33 (see FIG. 7).

By the use of the above described, preferred embodiment of the inventive teaching it is sufficient to form the shoulder 23 of the lid ring 20 with a width of only 2 mm, and in contrast to the state of the art where the necessary shoulder width is 3 mm. FIG. 6a shows that in a positioning station 4 according to the state of the art because of the support of the knife 46 an adhesion over the entire overlapping zone 31 is not possible.

In a further embodiment the connecting zone 33 has a width of less than 2 mm, down to 1.0 mm and the predetermined partial area a width of 1.5 to 0.5 mm.

FIG. 7 shows schematically a view of a connecting zone 33 divided into 4 sectors A, B, C and D. Each sector serves for the illustration of an exemplary embodiment, with regard to how the first adhesion occurs in the position station 4 and the following further adhesion step takes place in the processing station 7. The sectors A and B are subdivided into subsectors A 1 and A 2 and B 1 and B 2 with in the first subsector a re-adhesion being illustrated and the second sector a complementary adhesion being illustrated.

The subsector A 1 shows the relationship according to FIGS. 6a and 6b. The predetermined partial region 56 lies at the inner side of the connecting zone 33; a region of the further adhesion 61 (corresponding to the overlapping zone 52 of FIG. 6b) corresponds to the entire connecting zone 33 so that the predetermined partial region 56 (once again) is re-adhered.

In contrast to this, sector A 2 shows a complementary adhesion, in that after the predetermined partial region 56 a completing partial area 62 is adhered by the further adhering step. A re-adhesion does not take place. The recess zone of stamp 55 and/or the support 49 (in the further processing station 7) corresponds in its contour to the contact effective outer surface region of stamp 50 and/or the support 50 of the positioning station 4, that is of the covered zone 53.

A re-adhesion can be advantageous, if during the first adhesion in the predetermine partial region 56 the adhesion is not completely formed, be this because of a too short a period of time in the processing station 4 or because of an insufficient delivery of heat to the predetermined partial region 56.

An amount of time for remaining in the processing station 4 which is too short for a complete adhesion can be chosen if the stepping rate is so high, which means the period of each step is so short, that the stamping out and positioning of the foil blank 30 consumes too much of the step time remaining available and insufficient heat transfer can then occur if the temperature gradiant has to be chosen to be so high that within the in the remaining step time available an entire thorough warming of the adhesive mass cannot be assured or for different reasons the temperature is below that at which it should be held for a complete fluidizing of the adhesive mass.

A specialist in the art can in a concrete case, that is according to the foil used, the step time, the geometric shape of the predetermined partial region 56 and the required performance of the adhesion (burst pressure), and as the case may be by trials, make a choice between complementary adhesion and re-adhesion (or possibly partial re-adhesion).

Sector B shows a predetermined partial region 57 which no longer lies at the inner edge of the connecting region 33, but which is smaller and displaced toward the middle of connecting region 33. Preferably the width of the partial region 57 is 0.5 mm, but it can also deviate from this value. Such a configuration can be chosen if the foil blank 30 in the positioning station 4 after its positioning is to be only attached and the adhesion is to be principally carried out in the processing station 7. Again the subsector B 1 shows the predetermined partial region 57 as well as the region of the further adhesion 64 in the case of re-adhesion, and the subsector B 2 shows the complementary partial regions 63, 63′ in the case of a complementary adhesion.

Sector C shows several predetermined subregions 58 divided into a regular pattern which are adhered in the positioning station 4. A complementary partial region 65 is then complementarily adhered in the further processing station 7. As in the above examples a complete re-adhesion can also be carried out. Separated, predetermined subregions 58 are created in the effective outer surface region 51 (FIG. 6a) by removal of material from the surface so that recesses are made to allow the outer surface 51 to only come into contact with the connecting region 33 at the desired subregions 58. The same applies for the supplementary partial surface 65 of the stamp 55, etc.

Separated outer surface regions 58 can be provided by the specialist in the art, for example, in place of the small unbroken partial region 57 depending on the foil and adhesive parameters. For example then, if a foil in the adhesion process is not inclined to fail, point wise adhesion may be sufficient or indicated for other reasons.

A further implementation possibility is shown in sector D where the predetermined partial region 59 extends along and transversely through the adhesion region 33, which may be of significance in the case of a foil which in the adhesion process or upon the subsequent transport is inclined to failure. The region of the further adhesion 66 can be adhered complementary or by way of re-adhesion. As the case may be in this arrangement an unadhered edge region may be unavoidable or the partial region 59 may not extend over the entire width of the zone 33.

Further, for certain applications it may be beneficial if both the first adhesion in the positioning station 4 and also the second adhesion in the processing station 7 takes place over the entire connecting zone 33, with the consequence, that the entire adhesion connection is made twice. The overlapping zones 52 and 53 are then identical and likewise identical are the recesses in the effective outer surface regions of the stamp and of the support.

In the case of short step times, for example, it is advantageous to preheat the lid ring 20 by the preheating station 8 and to maintain the heat in or to again heat up the lid ring with the partially connected foil blank 30 by way of the preheating station 8′, so that the adhesive mass is optimally heated, preferably almost up to the condition of fluidity, before the further adhesion process is executed.

The invention, although by way of example a linear machine has been explained, is, as above mentioned, not limited to use in a linear machine. The method or the construction of the processing stations can be used in other processing machines, such as a carrousel machine.

It is within the scope of the invention to divide the adhesion process into more than 2 steps and correspondingly still further processing stations can be provided for the additional adhesion steps.

Although the inventive method as well as the inventive apparatus has been explained in connection with the making of a foil blank covered lid ring made of tin plate, these inventions are not limited to tin plate. For example, aluminum or some other shaped materials are suitable for use in the teaching of the invention, including non-metal lid rings, insofar as they have the necessary mechanical properties, for example, in respect to temperature stability.

Moreover not only lids can be covered with foil in accordance with the present invention, but also wall sections of a package, which for example have a ribbed structure, which are to be covered with foil blanks or a foil web.

While in the present application preferred embodiment of the invention have been described it should be clearly noted that the invention is not limited to these and that it can be carried out in other ways within the scope of the following claims.

1. A method for making a packaging element having a metallic cover carrier covered by a foil blank (30), preferably a lid for a package, in a processing machine having a processing station, preferably a linear machine (1), by which the foil blank (30) in the region of a connecting zone (33) is adhesively secured to the cover carrier of the packaging element, in which method in a positioning station (4) of the processing machine a foil blank (30) and a cover carrier are positioned relative to one another in a condition of being capable of being adhesively being secured to one another, characterized in that in the positioning station (4) directly upon the positioning a predetermined partial adhesion of the foil blank (30) and of the cover carrier to one another takes place, and in that in a further processing station (7) an additional adhesion step is executed so that by way of this the connection between the foil blank (30) and the cover carrier as a whole is strengthened.

2. A method according to claim 1 further characterized in that the adhesion takes place through the effect of heat and in the presence of an amount of adhesive which is applied to a foil (43) as a coating layer.

3. A method according to one of claims 1, further characterized in that the partial adhesion is created in that the adhesion is placed only in a predetermined partial region of the connecting zone (33) and/or the adhesion because of insufficient heat effect is not entirely formed.

4. A method according to claim 3, in which an opening (25) in the cover carrier is closed by the foil blank (30), with the connecting zone (33) of a predetermined width running along the edge of and around the opening (25) in an overlapping region (31) of the cover carrier and of the foil (43), further characterized in that the predetermined partial region (56) of the connecting zone (33) is formed smaller than the connecting zone (33) itself, but likewise runs uninterruptedly around the opening (25), and in that by way of the additional adhesion step in the further processing station (7) a compete adhesion over the entire connecting zone (33) is created.

5. A method according to claim 4, further characterized in that the predetermined partial region (56) is formed with a constant width along the inside edge of the opening (24), so that the outermost edge section (34) of the connecting zone (33) spaced from the opening (25) extends to the edge of the foil blank (30).

6. A method according to claim 5, in which the cover carrier formed as a lid ring (20) is covered to form a closed lid, further characterized in that the connecting zone (33) has a width of 2 mm or less, down to 0.1 mm, and the predetermined partial region (56) has a width of from 1.5 mm to 0.5 mm, preferably 1 mm.

7. A method according to claim 3 in which an opening (24) existing in the cover carrier is closed by the foil blank (30) with the connecting zone (33) having a predetermined width and running around the opening along the edge of the opening (24) in the overlapping region (31) of the cover carrier and the foil (33), further characterized in that the predetermined partial region of the connecting zone (33) is divided into individualized subregions (54) along the connecting zone (33).

8. A method according to claim 1, further characterized in that the cover carrier before the adhesion in the positioning station (4) and/or during the conveyance from the positioning station (4) to the further processing station (7) is held in a heated condition.

9. A processing machine, preferably a linear machine, for carrying out the method according to claim 1, for the making of package elements having a metallic cover carrier with a foil blank (30), preferably lids for packages made of sheet material, with an operable positioning station (4) cooperating with a conveyor (2), the positioning station (4) having positioning means for opposite sidedly positioning a foil blank (30) with a cover carrier of the packaging element and means for adhering the positioned foil section (30) with the cover carrier, in the region of a connecting zone (33), characterized in that a further operable processing station (7) cooperating with the conveyor and located behind the positioning station (4) in the conveying direction is provided, which further processing station (7) has means for continuing the adhesion of the foil blank (30) with the cover carrier.

10. A processing machine according to claim 9 further characterized in that the means for adhering and the means for continuing the adhering of the foil blank (30) each have heating means (8, 8′) which are formed to supply heat to a foil blank (30) and/or cover carrier brought into the positioning station (4) and preferably having pressure means for exerting pressure on predetermined regions of the connecting zone (33) of the foil blank (30) and/or the cover carrier.

11. A processing machine according to claim 9, further characterized in that the means for adhering and the means for continuing the adhering of the foil blank (30) to the cover carrier are formed with dissimilar geometries in order to be effective on different regions (56, 61; 57, 64; 58, 65; 59, 66) in the connecting zone (33) of the cover carrier and foil blank (30).

12. A processing machine according to claim 9, further characterized in that the positioning means and the means for adhering include a support (40) with a support surface (41) for a cover carrier especially formed as a lid ring (20), a foil cutting work tool (46) associated with the carrier (40) with a gripper (47) and a knife for cutting the foil blank (30) from a foil web delivered to the positioning means and at least one operable stamp (50) cooperating with the support (40) and the foil cutting work tool (46) for positioning a cutout foil blank (30) onto the cover carrier, especially the lid ring (20) supported on the support (40), with the support (40) and the stamp (50) being movable toward and away from one another between an adhering position for the foil blank (30) and the cover carrier and loading/removing position for the cover carrier, with the stamp (50) being arranged in the interior space of the circumference of the foil blank (30) cutting knife and being telescopically shiftable relative to the knife, and with the outer surface region of the support surface (41) and of the stamp (50) which are directly facing one another in the adhesion position partially overlapping one another and being suited in the overlapping zone (53) region of a cover carrier and the foil blank position thereon to being in contact with the cover carrier and the foil blank to form an adhesion between the cover carrier and the foil blank.

13. A processing machine according to claim 12 further characterized in that the width of the overlapping zone (53) of the support surface (41) and the stamp (50) in the positioning station (4) is smaller than 2 mm, preferably smaller than or about 1.5 mm, and especially preferably 1 mm.

14. A processing machine according to claim 13, further characterized in that the width of the overlapping zone (53) is 0.5 mm.

15. A processing machine according to claim 9, further characterized in that at least one of the outer surface regions (41, 51; 60,70) which directly face one another in the overlapping zone (52, 53), preferably that of the stamp (50), has at least one zone with a surface recess which reduces the contact effective outer surface region of the overlapping zone (52, 53) for the adhesion.

16. A processing machine according to claim 15, further characterized in that in an outer surface region (41, 51; 60, 70) several recesses are arranged preferably in a uniform pattern.

17. A processing machine according to claim 9 further characterized in that the means of the further processing station (7) for the continuation of the adhesion of the foil blank (30) with the cover carrier includes a support (49) with an annular support surface (60) for a cover carrier, especially a lid ring (20), and a stamp (55) cooperating with the support (49) for the continued adhesion of a foil blank (30) with a cover carrier resting on the support (49), with the support (49) and the stamp (55) being movable toward and away from one another between an adhering position for the foil blank (30) and the lid ring (20) and a loading/removing position for the lid ring (20) and with outer surface regions of the support surface (60) and of the stamp (55) which are directly facing one another in the adhering position partially covering one another and being suited in this overlapping zone region of a cover carrier and a foil blank (30) position on the cover carrier to contact the cover carrier and the foil blank thereon for adhering the cover carrier and the foil blank to one another.

18. A processing machine according to claim 17 further characterized in the covering zone of the support (49) and the stamp (55) in the further processing station (7) having a larger width than that in the positioning station (4).

19. A processing machine according to claim 17, further characterized in that the covering zone of the support (49) and the stamp (55) in the further processing station (7) being of the same width as that of positioning station (4).

20. A processing machine according to claim 18 further characterized in that at least one of the outer surface regions which directly face one another in the covering zone (53) of the further processing station (7), preferably that of the stamp (55), has at least one zone with a surface recess which reduces the outer surface region of the covering zone (52) which is contact effective for the adhesion.

21. A processing machine according to claim 20 further characterized in that the at least one recess of the further processing station (7) in its contour corresponds to the contact effective outer surface regions of the covering zone (53) of the positioning station (4).

22. A processing machine according to claim 9 further characterized in that in advance of the positioning station (4) and/or in advance of the further processing station (7) heating means (8, 8′) are provided to preheat the cover carrier or the cover carrier with the adhered foil blank (30) for the following adhesion step.

23. A lid ring (20) made of sheet material, preferably aluminum sheet or tin plate sheet covered by a foil blank (30), with the lid ring having an annular projecting shoulder (23) in the interior of the lid for connection with the foil blank (30), characterized in that the width of the shoulder (23) is 2.5 mm or less, preferably 2.0 mm.

24. A lid ring (20) made of sheet material, preferably aluminum sheet or tin plate sheet, covered by a foil blank (30), with the lid ring having a projecting shoulder (23) in the interior of the lid ring, onto which shoulder the foil blank (30) lies and is connected to the lid ring by adhesive, characterized in that the width of the edge of the foil which lies on the shoulder (23) is less than 2.5 mm, and is preferably 2 mm.
